(19) United States
(12) Patent Application Publication
(10) Pub. No.: US 2017/0247934 A1
(43) Pub. Date: Aug. 31, 2017

(54) MOLDED DOOR SKIN WITH INTEGRAL DIVIDED LIGHT BARS AND DOOR MANUFACTURED THEREWITH

(71) Applicant: MAXCRAFT DOORS, INC., Duluth, GA (US)

(72) Inventor: Zhihua Cai, Suwanee, GA (US)

(21) Appl. No.: 15/443,450

(22) Filed: Feb. 27, 2017

Related U.S. Application Data
(60) Provisional application No. 62/299,807, filed on Feb. 25, 2016.

(51) Int. Cl. E06B 3/58; E06B 3/70; E06B 3/68; E06B 3/78; E06B 3/30; E06B 3/56

(52) U.S. Cl. CPC E06B 3/5892; E06B 3/30; E06B 3/56; E06B 3/685; E06B 3/78; E06B 3/7001; E06B 2003/7049

(57) ABSTRACT

A molded door skin with integral divided light bars. The divided light bars are either true divided light (TDL) bars simulated divided light (SDL) bars or decorative grilles. The door skin includes a body portion and a divided light bar portion. The body portion and divided light bar portion are of one-piece construction which is preferably compression molded from fiberglass or other synthetic materials. Once assembled into a door with door glass installed, the divided light bars form a number of small windows for either simulating the appearance of traditional divided light windows in SDL applications, holding individual panes of insulating glass units in TDL applications, or for decorative purpose only.

### CROSS REFERENCE TO RELATED APPLICATION

This application claims the benefit of U.S. Provisional Application No. 62/299,807 filed Feb. 25, 2016.

### BACKGROUND OF THE INVENTION

The invention relates to molded door skins and doors manufactured therewith, and more particularly, to a molded door skin and door with integral divided light bars that can be used either as true divided light TDL muntin bars or simulated divided light SDL muntin bars or decorative grilles.

Large pieces of glass used to be expensive to manufacture, so windows were made up of several pieces put into wooden frames. These are known as TDL windows—having multiple pieces of glass that are separated by wooden muntin bars. TDL light glass is still limited to applications in wood windows and doors with wooden muntin bars.

While TDL windows are attractive, they are expensive to fabricate. An inexpensive alternative to true divided light is SDL. SDL windows feature a single piece of glass with SDL bars permanently adhered to both sides of the glass to give it the appearance of a TDL window.

Fiberglass doors, especially flush-glazed fiberglass doors, with SDL door glass are one of the most popular designs on the market. As mentioned earlier, SDL door glass features SDL bars adhered to the indoor and outdoor surfaces of the glass. Adhering SDL bars to the surface of the glass manually is very labor intensive. The look of the manually applied SDL bars are kind of low end.

There is a strong demand for a more efficient and cost-effective way of making fiberglass doors with high end divided light bars.

Methods of making simulated divided light windows are disclosed in U.S. Pat. No. 4,598,520, U.S. Pat. No. 4,783,938, U.S. Pat. No. 6,177,156, U.S. Pat. No. 7,854,097 and U.S. Pat. No. 5,345,743. But all of them relate to manually adhering SDL bars or glazing sheets to glass.

Accordingly, an objective of the present invention is to provide a decorative door having a TDL appearance that is less expensive to manufacture, structurally stronger and looks better.

Another objective of the present invention is to provide a decorative door that is less labor intensive to manufacture.

These and other objectives will be apparent to those skilled in the art based upon the following written description, drawings and claims.

### SUMMARY OF THE INVENTION

The present invention provides a mass production method of making molded door skins with integral divided light bars at low cost. The door skin includes a body portion and a divided light bar portion. The body portion and divided light bar portion are of one-piece integral construction of the same material. The door skin with integral divided light bars is preferably made of compression molded thermosetting synthetic/fiberglass. The cross section of the divided light bars is not limited to the cross section shown in the preferred embodiments. Different sizes and divided light patterns are made available through the use of different molds. Two such door skins, interior door skin and exterior door skin, are normally needed in the making of the door with divided light bars. The divided light portions on the interior and exterior door skins form a number (typically 2, 3, 4, 5, 6, 8, 9, 10, 12, 15 and 18) of openings/lights in TDL and SDL applications or any more than 2 openings in decorative grille applications.

In a TDL application, individual pieces of insulating glass units, preferably with bevels, are each put into one of the openings/lights and caulked/bonded to the inner side of the surrounding divided light muntin bars with glass stops. Using securing bars to further help to prevent the divided bars from separating from the glass units is optional.

In an SDL and decorative grille application, a single piece of insulating glass unit (with or without internal shadow bars/spacers) is caulked/bonded to the back of interior and exterior door skins along the perimeter of the door glass opening. And the various numbers of small windows/lights formed by the divided light bars are to simulate the appearance of true divided light windows or for decorative purpose. Applying double sided SDL tape or caulk between the glass and divided light bars is optional.

### BRIEF DESCRIPTION OF THE DRAWINGS

FIG. 1 is a front view of a molded door comprising the door skin with integral true divided light muntin bars (with beveled glass) of this invention;

FIG. 2 is a perspective back view of a molded door skin with integral true divided light muntin bars having bore type glass stops of this invention;

FIG. 3 is a cross section view taken along line A-A in FIG. 1;

FIG. 4 is an exploded oblique view showing the key components (door skin and glass) of a door comprising the door skin with integral true divided light muntin bars with beveled glass units of this invention;

FIG. 5 is a perspective back view of a molded door skin with integral true divided light muntin bars having double-walled glass stops of this invention;

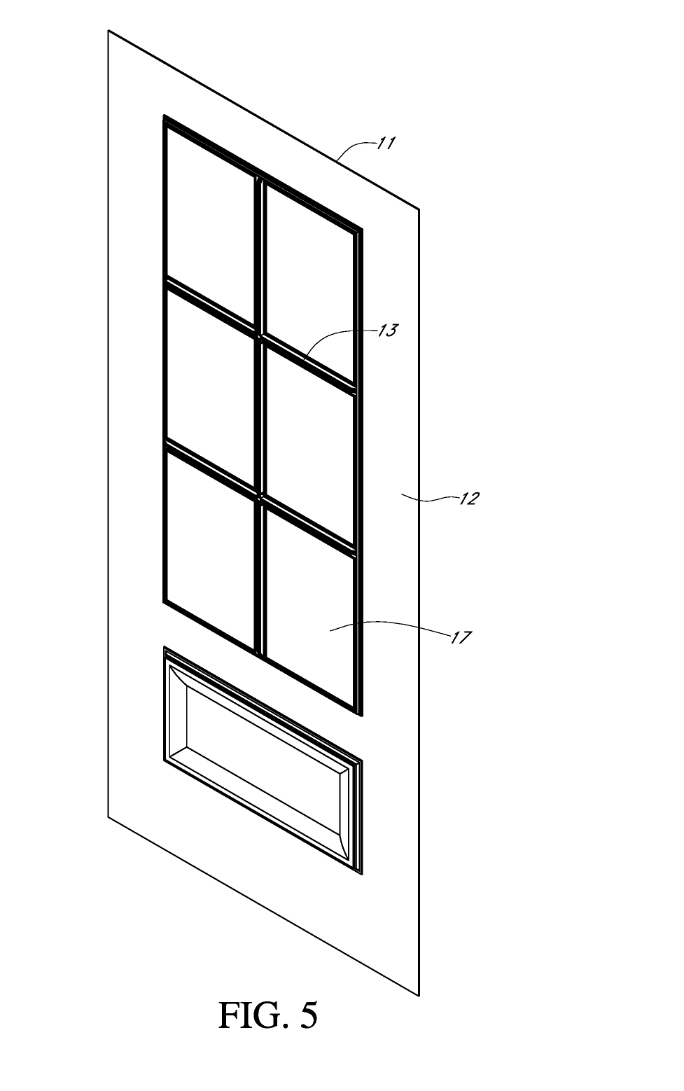

FIG. 6 is an exploded perspective view of a molded door skin with integral true divided light muntin bars having double-walled glass stops of this invention;

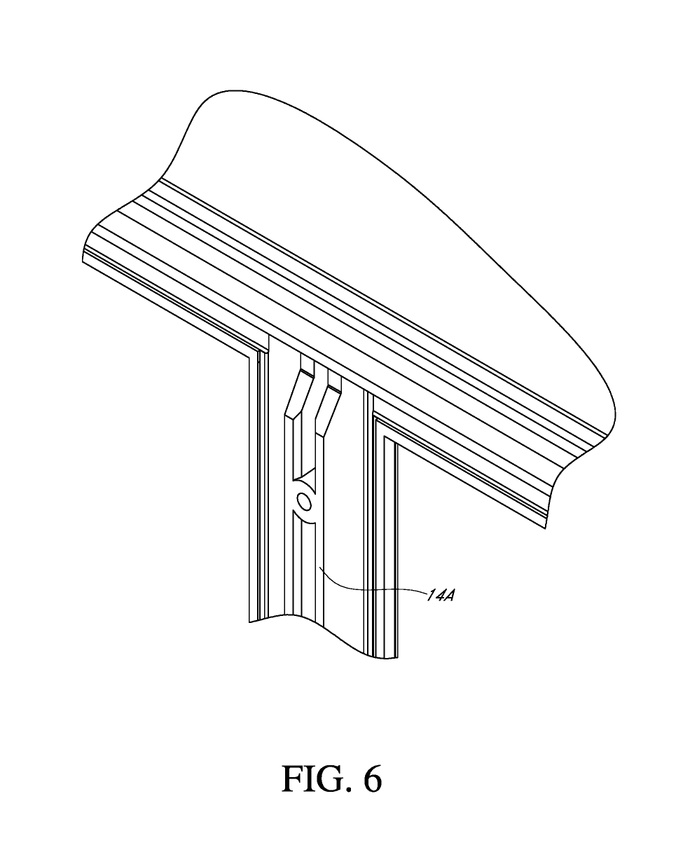

FIG. 7 is a front view of a molded door comprising the door skin with integral simulated divided light bars of this invention;

FIG. 8 is a perspective back view of a molded door skin with integral simulated divided light bars of this invention;

FIG. 9 is a cross section view taken along line B-B in FIG. 7;

FIG. 10 is an exploded oblique view showing the components of a door comprising the door skin with integral simulated divided light bars of this invention; and

FIG. 11 is s a front view of a molded door comprising the door skin with decorative grilles of this invention.

### DETAILED DESCRIPTION OF THE PREFERRED EMBODIMENT

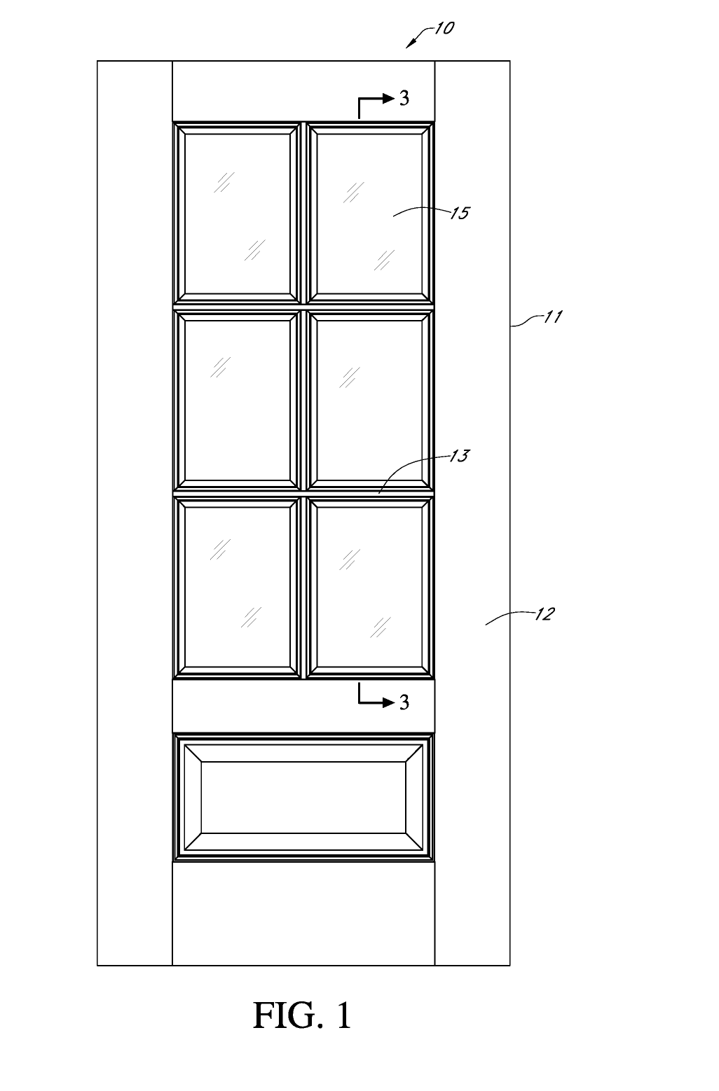

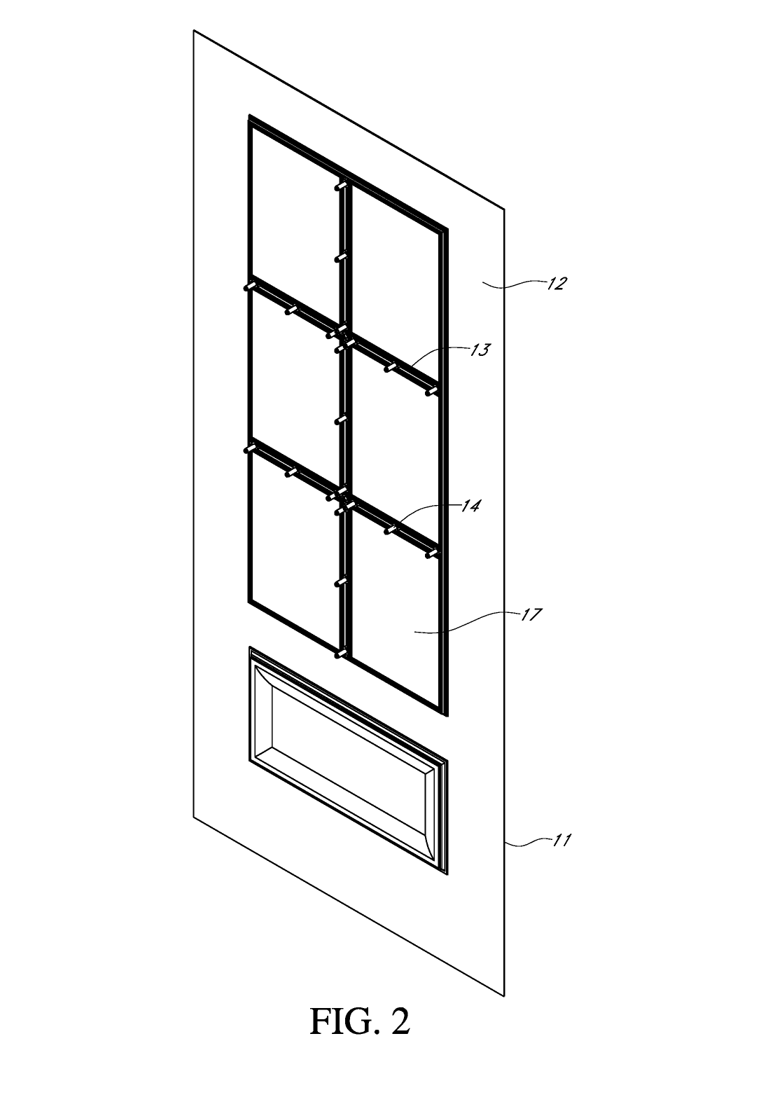

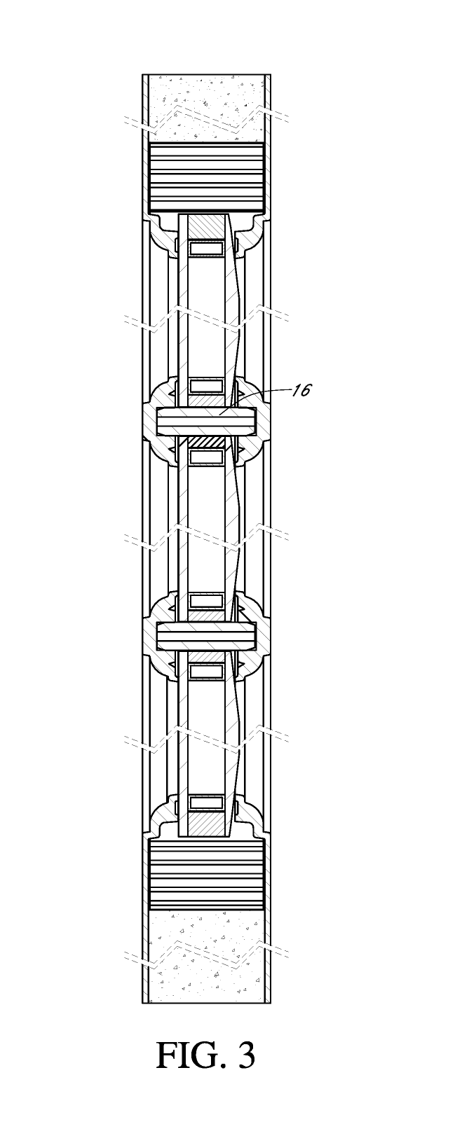

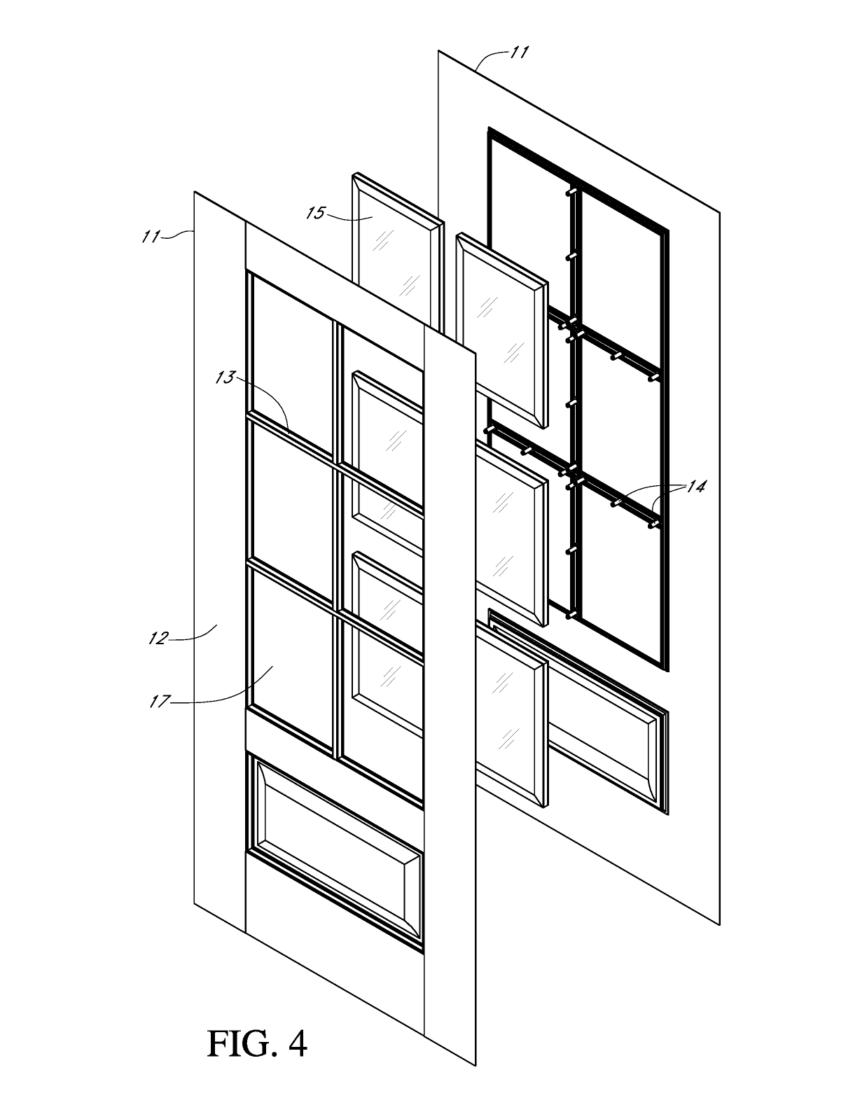

Referring to FIGS. 1-4, a door member 10 with the door skin 11 is illustrated. The door skin includes a body portion 12 and a true divided light muntin bar portion 13. The body portion 12 and true divided light muntin bar portion 13 are of integral one-piece construction. The door skin 11 with integral true divided light muntin bars 13 is preferably made of compression molded thermosetting synthetic/fiberglass.

The true divided light muntin bar portion 13 consists of molded true divided light muntin bars 13 forming a number (minimum 2) of openings/lights 17 for holding individual pieces of insulating glass units 15. There are a number of glass stops 14 on the back of true divided light muntin bars 13 to keep the individual pieces of glass units 15 in position. These glass stops 14 are preferably an integral molded part of the door skin 11. The glass stops 14 can also be add-on components made of any material. When the glass stops 14 are add-on components, they can be either glued or screwed to the back of the true divided light bars 13. The glass stops can be screw bores 14 or double-walled ribs 14A. Individual pieces of insulating glass units 15, preferably with bevels, are each put into one of the openings 17 and caulked/bonded to the back of the surrounding divided light bars 13 of both an interior and an exterior door skins 11. These individual pieces of insulating glass units 15 are initially kept in position by glass stops 14 before they are caulked/bonded to the back of the surrounding divided light bars 13 of both the interior and exterior door skins 11. Optionally, a securing bar 16 of either fiberglass, wood, metal or any synthetic material connects the opposite glass stops 14 on the interior and exterior door skins 11 to further help to prevent the divided light muntin bars 13 from separating from the glass units 15. When used, the securing bar 16 is normally glued to the glass stops 14. Securing bars 16 can also be an integral part of one door skin 11 as the male part while there will be a female receiving bore on the other door skin 11. A spacing of about 1/16″ between the edge of the glass unit 15 and glass stop 14 is needed to accommodate manufacturing tolerance and different expansion/contraction of divided light bars and glass units 15.

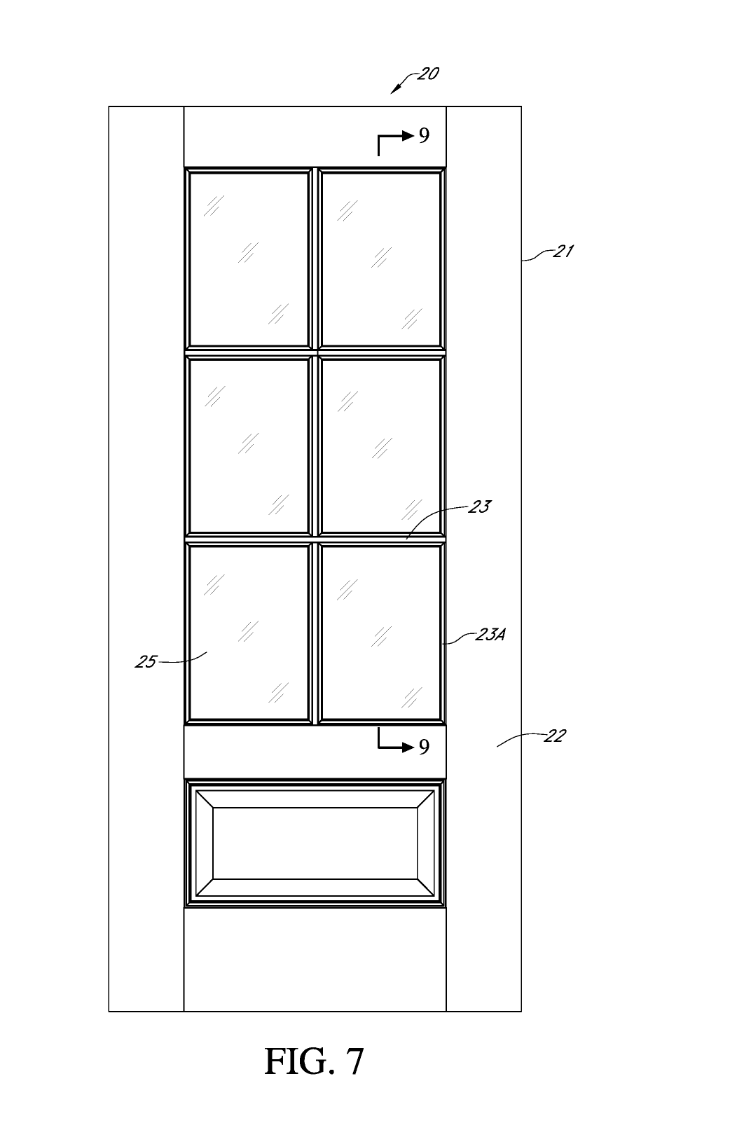

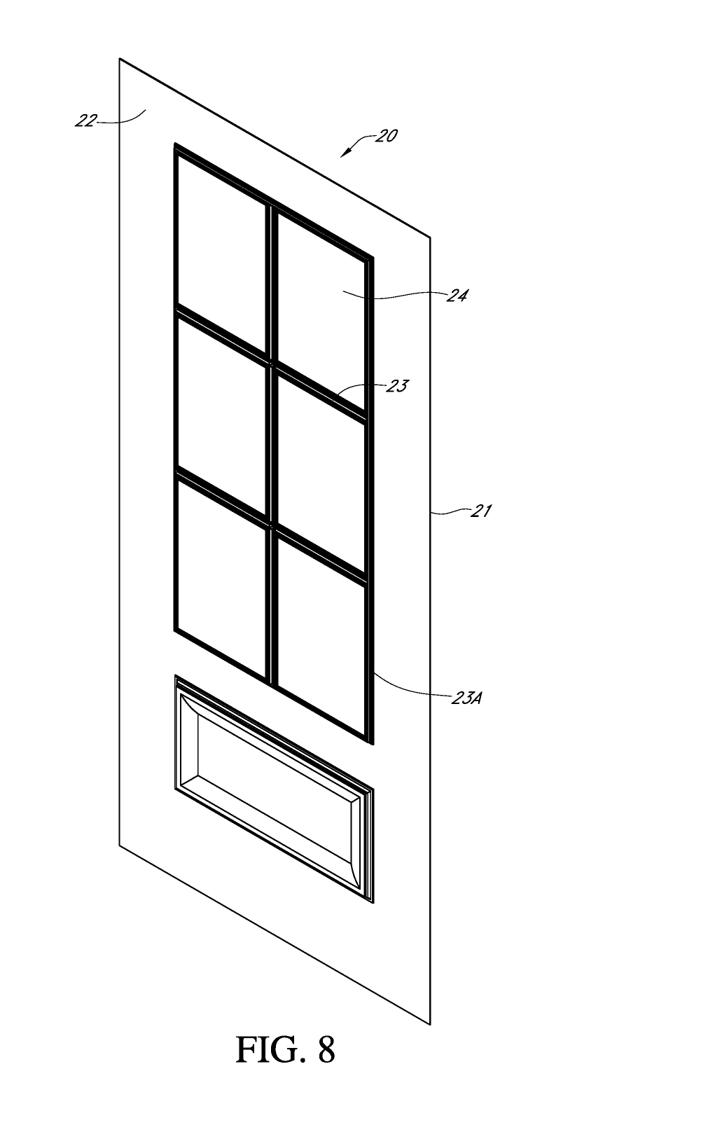

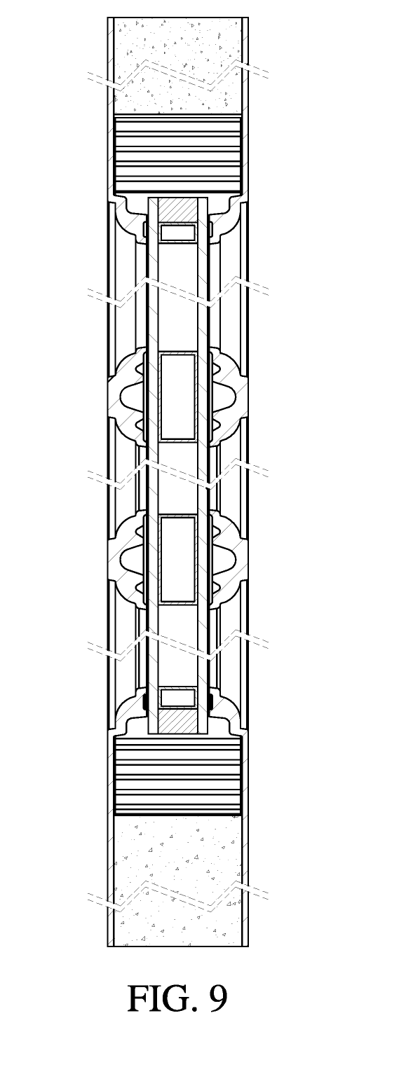

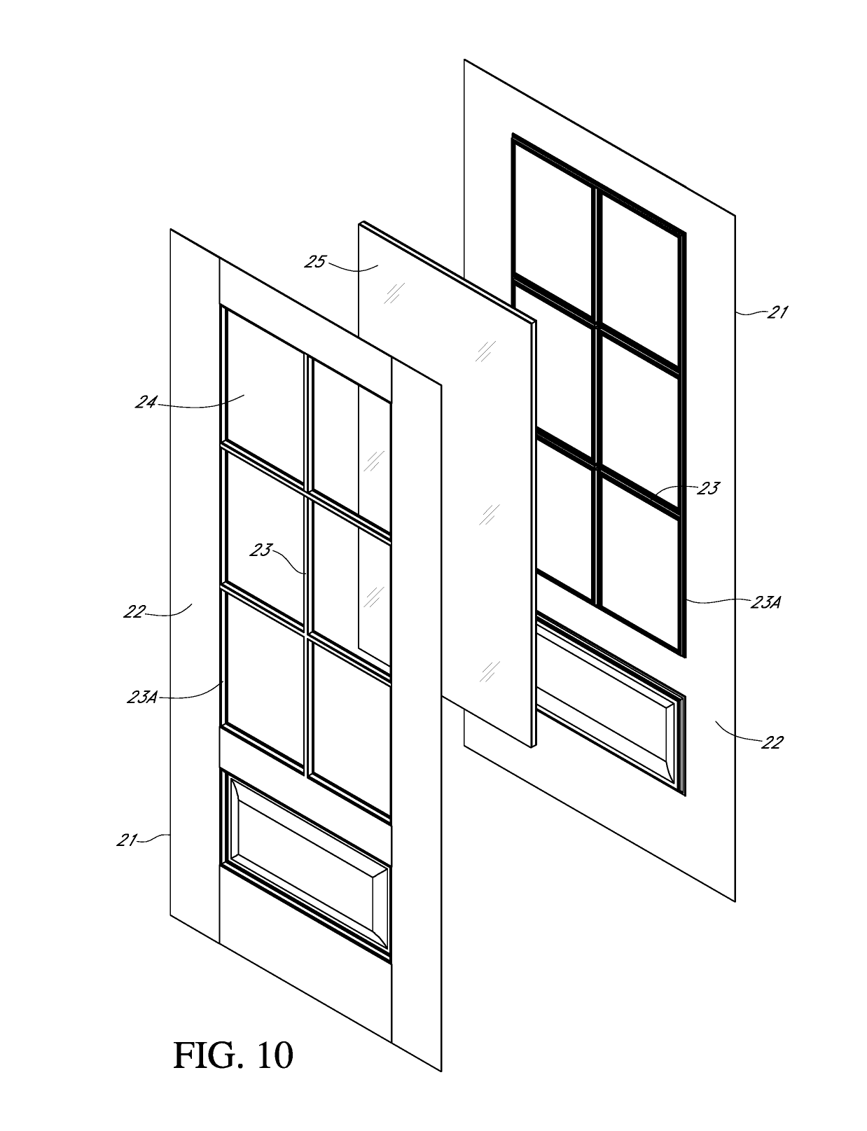

Referring to FIGS. 7-10, in another embodiment, shown is a door member 20 with the door skin 21. The door skin 21 includes a body portion 22 and a simulated divided light bar portion 23. The body portion 22 and simulated divided light bar portion 23 are of integral one-piece construction. The door skin 21 with integral simulated divided light bars 23 is preferably made of compression molded thermosetting synthetic/fiberglass.

The simulated divided light bar portion consists of molded simulated divided light bars 23 forming a number (minimum 2) of openings/lights 24 to simulate the appearance of true divided light windows. A single piece of insulating glass unit 25 (with or without internal shadow bars/spacers) is caulked/bonded to the back of interior and exterior door skins 21 along the perimeter 24 of the door glass opening. Various numbers of openings/lights formed by the divided light bars are to simulate the appearance of true divided light windows.

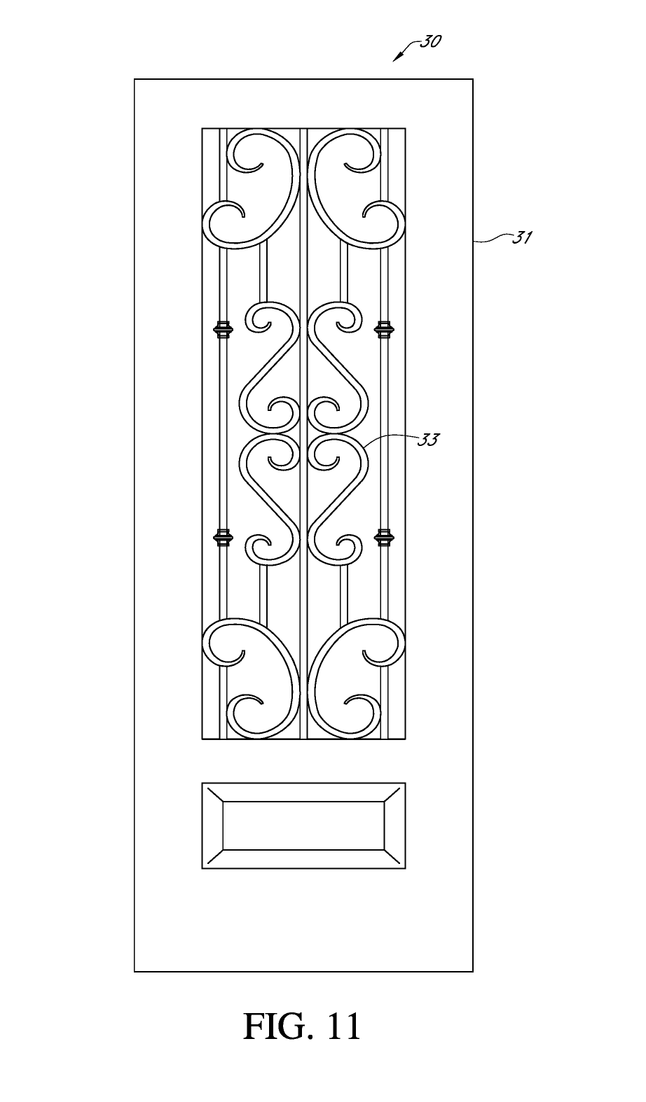

Referring to FIG. 11, in another embodiment, shown is a door member 30 with the door skins 31 having integral decorative grilles 33. Similar to the previous embodiment, a single piece of insulating glass unit 34 is caulked/bonded to the back of interior and exterior door skins 31 along the perimeter of the door glass opening. The grilles 33 are used as a decorative feature.

What is claimed is:

1. A decorative door, comprising:
a molded door skin having an integral body portion and true divided muntin bar portion that forms openings/lights.

2. The door of claim 1 wherein the door skin is made of a compression molded synthetic material.

3. The door of claim 1 where individual glass units are put in the openings, attached to a back of the true divided light muntin bar portion and held in position by glass stops.

4. The door of claim 1 where a plurality of glass stops are positioned on the back of the true divided light muntin bar portion.

5. The door of claim 4 wherein the glass stops are integral to the true divided light muntin bar portion.

6. The door of claim 4 wherein the glass stops are selected from a group consisting of screw bores or double-walled ribs.

7. A decorative door, comprising:
a molded door skin having an integral body portion and simulated divided muntin bar portion that forms openings/lights.

8. The door of claim 7 wherein a single piece of glass unit is bonded to the back of the door skin around the perimeter of the glass opening.

9. The door of claim 7 wherein a single piece of glass unit is bonded between a first door skin and a second door skin.

10. The door of claim 7 wherein the simulated divided light muntin portion is a decorative grille.
